(19) United States
(12) Patent Application Publication
(10) Pub. No.: US 2007/0227064 A1
(43) Pub. Date: Oct. 4, 2007

(54) Growing Platform for Green Matter as a Feed Base for Animals

(76) Inventor: Wolfgang Gees, Schloss Holte-Stukenbrock (DE)

Correspondence Address: LERNER GREENBERG STEMER LLP, P O BOX 2480, HOLLYWOOD, FL, 33022-2480, US

(21) Appl. No.: 11/578,921

(22) PCT Filed: Apr. 15, 2005
(86) PCT No.: PCT/DE05/00656

§ 371 Date: Oct. 19, 2006

(30) Foreign Application Priority Data
Apr. 19, 2004 (DE) 20 2004 007 514.8
Jul. 1, 2004 (DE) 20 2004 010 397.4
Feb. 23, 2005 (DE) 20 2005 002 889.4

(51) Int. Cl. A01G 13/02

(52) U.S. Cl. 47/20.1

(57) ABSTRACT

A growth platform for greenery includes an initial/refill packet of seed and growth agent is housed in a base container and covered with a lid configuration. The lid is formed with openings (holes), so that the animals can neither reach the growth agent, nor the seed. In addition, the entire system has a cover or covering to ensure undisturbed initial growth and regrowth, similar to a greenhouse. The three base components, in addition to the covering are interconnected and located one inside the other according to all possible technical implementation options. The growth platform can be a separate product, or a product that can be inserted or attached. All materials, shapes, colors and configurations can be envisaged in order to satisfy the generic concept. The entire system conforms to zoological and botanical specifications.

The invention relates to growing platforms for green matter according to the preamble of the principal claim, as an individual product or also as an integrative product, that is to say an annexable product.

Many animals need green matter (plants), on the one hand as feed (rodents, reptiles, birds, etc.), and on the other hand in order to clear their gastro-intestinal tract of hairs (for example cats). Conventional products available on the market, such as those known as cat grass or rodent grass, are offered for sale in containers.

A growing medium in the form of a granulate including seed is introduced into a container of this kind. The green matter is brought into growth out of reach of the animals by the addition of liquid and is then made available to the animals for consumption. The disadvantage is that cats, for example, also pull out the roots in conjunction with their consumption of the green matter, and that they may also dig into the material and defecate in the granulate. On the other hand, there is also the possibility that rodents, for example, may nibble the container itself.

An animal keeper is thus presented as a rule with only a single use, an unhygienic platform and, as an associated effect, a certain quantity of dirt.

The object of the invention is to make available a significantly better solution. This object is achieved in conjunction with the characterizing features of the preamble according to the invention by the indicated technical theory.

The growing platform according to the invention consists of a basic container to receive growing media such as soil, gauzes, waddings, granulates, etc., as a recipient for various seeds (plants), etc., which are already available in the world market. The basic container according to the invention can be manufactured from all available materials according to the prior art.

In order to deny the animals access to the growing granulate in conjunction with their consumption of the green matter, a cover is arranged according to the invention above the basic container, which cover is perforated in any way in all conceivable forms (round, square, oval, etc.). The cover according to the invention and the covering can be manufactured from all available materials according to the prior art.

It is also envisaged that the openings in the cover/covering will possess a sufficiently large diameter to permit the green matter to grow through, while preventing the green matter from being pulled out by the roots, because plants, at the point where they emerge from the granulate (growing medium), as a general rule exhibit a thickening larger than that of the actual growing shoot once it has passed through the holes.

Account is thus taken of the principal claim of this invention, in the sense that the animals are not able to gain access to the growing medium so that they are able to dig in it and to defecate in it, etc. The basis is created in this way for ensuring that the green matter remains undisturbed and is also able to grow more frequently.

In the event that the animal has now grazed (eaten) the green matter, for whatever reason, the growing platform product as a whole has a further cover, which provides for further, undisturbed growth in such a way that it lies as far as possible level with the plurality of openings according to the invention above the basic container and the cover (covering). This further cover can be manufactured from all available materials, in any form and in any color, according to the prior art.

In order to satisfy the principal claim, this cover can also be regarded as a greenhouse cover, such that a microclimate develops under this cover, so that plants are able to grow very rapidly and well. In order to create conditions like those in a greenhouse, this upper cover can be provided with openings of any kind in order to ensure air circulation.

It is ensured in this way that the plants grow, and that stagnant heat, etc., cannot give rise to rotting or to all conceivable kinds of occurrences which stand in the way of the invention and the achievement of its object.

To ensure that the three elements according to the invention, these being the basic container, the perforated covering (cover) and the greenhouse cover, constitute a fixed unit in many phases of its use, such as renewed growth, it is proposed in one embodiment, for example, to introduce and/or attach hinges or other locking systems according to the prior art.

The three elements are thus combined with one another, for example in a single hinged system. On the opposite side of the hinged system, the three component parts according to the prior art exhibit a securing section, so that animals are not able to open the entire complex.

In a second embodiment, the containers are attached to one another under tension.

All solutions that are available according to the prior art are applicable in order to satisfy the technical theory and the level of the principal claim according to the invention.

In another embodiment according to the invention, the growing platform can also be an integrative component part of an animal house, such as a so-called rodent house. The growing platform in this case also serves as greenery on the roof and as such meets the fundamental statement of the principal claim according to the invention, namely to make feed available of a kind which is used by cats to clear their stomach/intestine.

The growing platform can be incorporated in and/or annexed to products of any kind in any form and embodiment according to the invention.

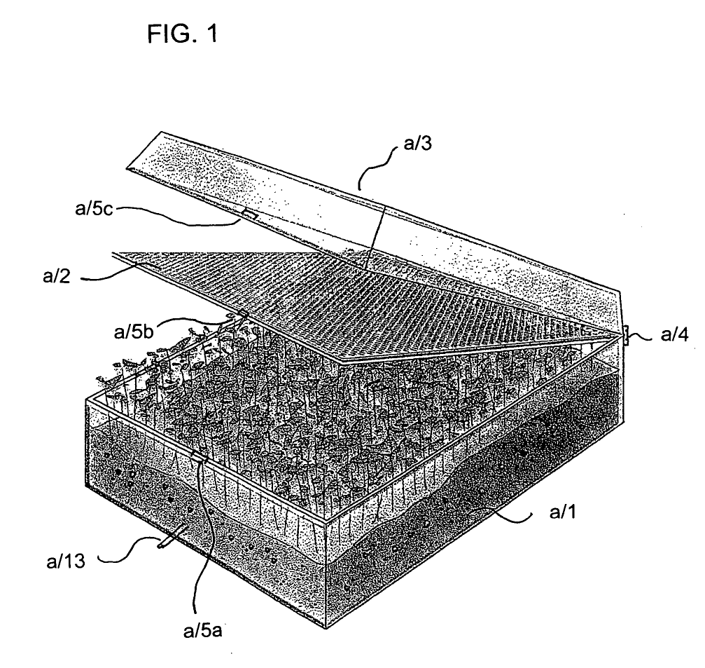

FIG. 1:

An embodiment described in the text is depicted in FIG. 1 with reference to a schematic drawing:

(a/1) shows the basic container for receiving basic substances and plants (seeds, etc.). (a/2) shows the middle cover lying on (a/1) in the closed condition, which cover is provided with openings to permit the growth of the green matter, but to prevent the green matter, including its roots, from being pulled out in conjunction with its consumption or opening. (a/3) shows the upper cover or covering, which, with the entire product in its closed state, is connected to (a/1) above (a/2), so that regrowth of the green matter can be regarded as being similar to that in a greenhouse, but without the animals being able to impede the growth.

Once the green matter has reached the desired size, (a/3) is raised or removed and the animals can then graze. Among other things, (a/3) can be curved in an upward direction, and/or it can also be like a tent or have other conceivable forms. As a general rule, the entire object is made from materials which permit all the light to pass through, and in every case takes into account the necessary conditions for the supplied green matter.

In this case, (a/4) indicates the area of the hinges. (a/5a), (a/5b) and (a/5c) indicates the ability of the system to be securely closed, but without animals being able to open it. (a/13) here indicates a moisture outlet facility in (a/1).

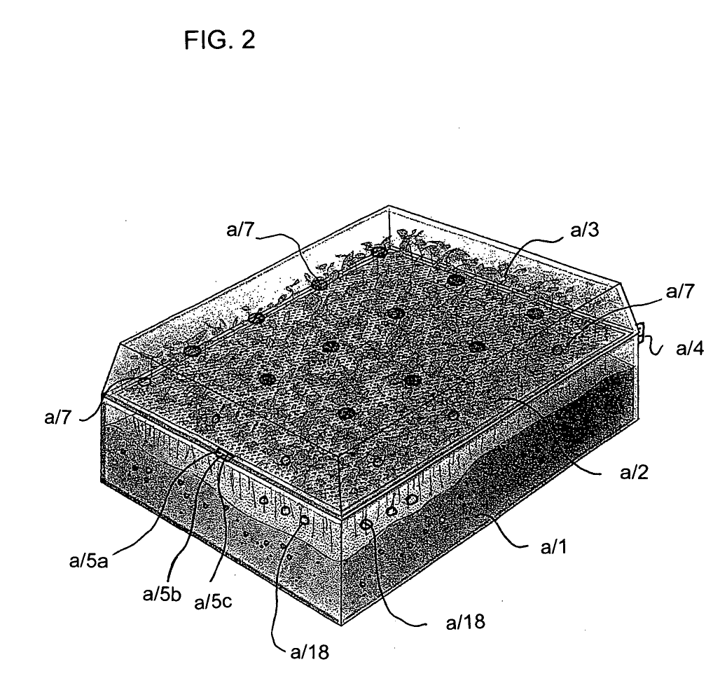

A further embodiment according to the invention is depicted in FIG. 2, where the growing platform as a whole is illustrated in a closed state to permit new growth to take place. Here, (a/1), (a/2) and (a/3) are connected via a hinge system. (a/5a) and (a/5b) together with (a/5c) illustrate the locking of the growing platform. (a/7) here indicates the facility for ventilation, similar to that in a greenhouse in (a/3).

(a/18) indicates additional ventilation openings in the vicinity of the basic vessel (a/1). All conceivable possibilities according to the prior art can be considered for the ventilation in order to satisfy the principal claim of this invention.

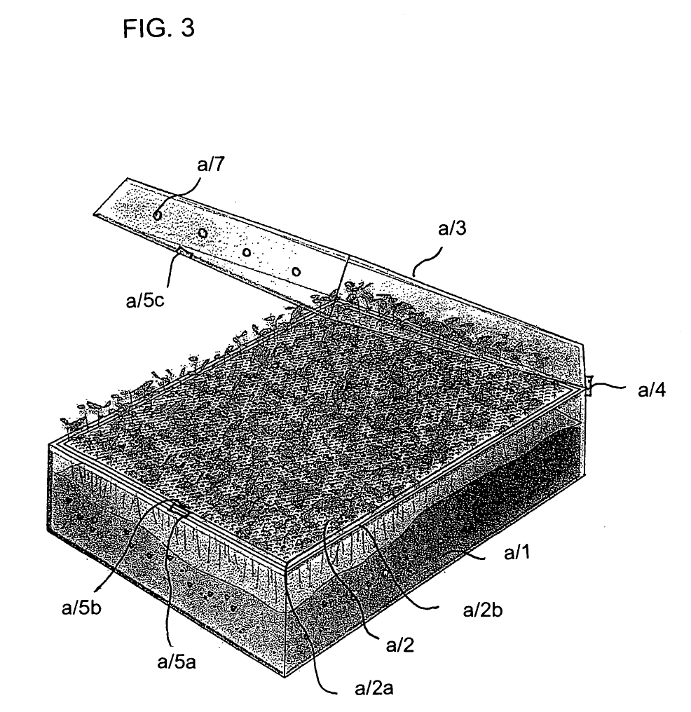

A further embodiment according to the invention is depicted in FIG. 3.

FIG. 3 indicates the, in an embodiment (a/2) of two perforated covers/coverings that are oriented so that they are level one above the other, which consists of a single unit or two separate units, these are arranged at a certain distance from one another or in relation to one another. (a/2b) is the lower cover with perforations facing towards the granulate (growing substance), having openings of a diameter sufficiently large to permit the stem of the plant to pass through, but not so large that the roots can be pulled out in conjunction with eating (consumption).

(a/2a) is arranged so that it is level at a certain distance to (a/2b), so that (a/2a) can also have larger openings. In the interjacent space between (a/2b) and (a/2a), the green matter cannot be reached by the animals. This has the advantage that the green matter, once it has grown through (a/2b), maintains its growth path and direction through (a/2a) as it regrows.

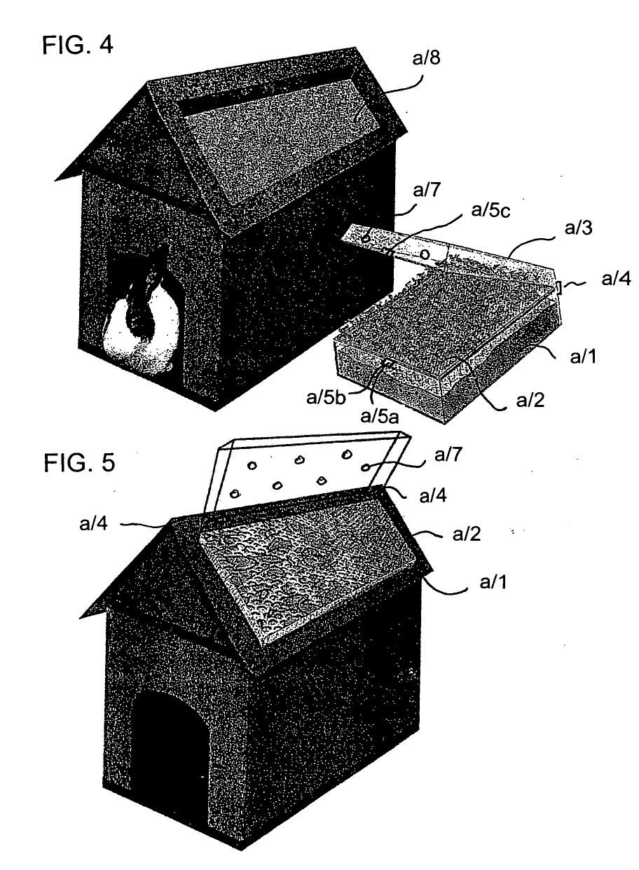

In a further described embodiment of the invention, the integration in an animal house (in this case a rodent house) is described in FIGS. 4 and 5:

(a/8) is the roof recess for the integration of the entire growing platform complex. The growing platform (a/1) as a whole with (a/2) and (a/3) fits in the recess (a/8) of the rodent house. The growing platform is constructed in a similar manner to that depicted in FIG. 2.

The green matter has grown in FIG. 5, and the greenhouse cover (a/3) is folded back over (a/4) or is removed in the event of a shortage of space in an ordinary animal house. The animal is thus able to gain access to the green matter.

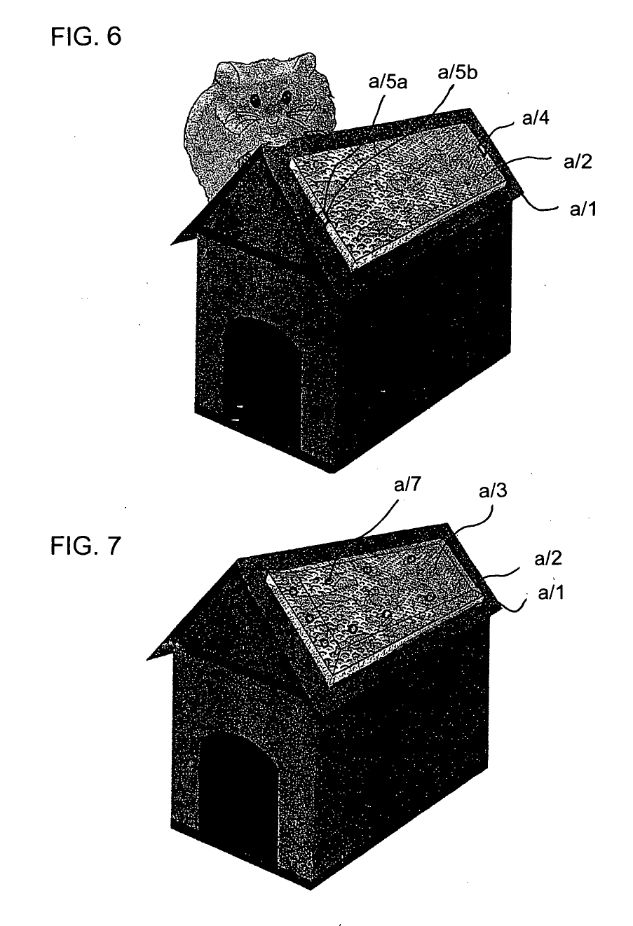

The manner in which the animal grazes is depicted according to the invention in FIG. 6. The greenhouse cover (a/3) in this situation is removed, and (a/1) with (a/2) intersect level with the roof construction of the rodent house or animal house.

The embodiment of this invention is depicted in sequence in FIG. 7, in the sense that (a/3) has now been brought level over (a/2) and (a/1) for further growth and via described hinge systems and an attachment system, which are already familiar in the prior art and constitute a fixed unit that cannot be opened by the animals.

In another embodiment according to the invention, however, (a/3) can also be inserted into (a/1) above (a/2) with a perfect fit, so that hinges and other attachment systems can be dispensed with.

In this embodiment, (a/1) and (a/2), as well as (a/3), are then connected inside one another and to one another as a stable plug-in system, without the animals being able to open the growing system or one or a number of elements thereof.

In another embodiment, not depicted schematically here, a refill pack (repeat purchase pack) (a/21) is placed in the basic container (a/1), which pack is filled with growing substances (soil, granulates, etc.) and seeds (plants).

This refill pack (repeat purchase pack) has protrusions and recesses, of whatever form, at or in its base to enable the corresponding parts of the basic container (a/1) to be accommodated. At or on its inner base, the basic container (a/1) has transverse struts or poles of some other form, securely anchored over the length, or the width, or the diagonal or the vertical, which fit perfectly into the recesses or protrusions of the base of the refill pack or the repeat purchase pack (a/21), so that non-standard packs of growing substances and seeds or plants will not fit into the overall product. Consideration has also been given to the manufacture of the refill pack (repeat purchase pack) (a/21) from materials which decompose after a certain period in contact with liquid. The possibility also exists of introducing a fleece, facing towards the base, into the refill pack (repeat purchase pack) (a/21) or into the basic container (a/1), which fleece assumes the task of water transport in the event of regrowth, or also initial growth, to all the roots of the introduced green matter (capillary effect, blotting paper principle). Furthermore, the refill pack (repeat purchase pack) (a/21) includes moisture outlet facilities, similar to the basic container (a/1) and designated as (a/13), to protect against rot and mold attack or saturation of the introduced plant material.

In a further embodiment, consideration has been given to the need for the cover/covering (a/2) to have parallel oriented bars and/or strips, which posses a minimum width of at least 2 cm, and do not run parallel and adjacent to one another in the horizontal sense, but vertically adjacent to one another, so that they achieve a height of at least 2 cm. Facing towards the granulate, as in an embodiment in (a/2) a level cover is applied over the entire surface, which cover contains holes that are only sufficiently large to permit the passage of the green matter, but not the thickening at the point where the green matter leaves the growing granulate. This is intended to prevent the animals from pulling out the green matter complete with its roots, or from eating it too far down, which would prevent regrowth. Consideration has also been given to the provision on the basic container (a/1) of holders of any kind whatsoever, so that the animal owner can provide additional rodent stones, mineral stones, as well as pieces of wood all the way round for gnawing, in this case similar to a palisade fence. The possibility is also considered of surrounding the basic container (a/1) or the greenhouse cover (a/3) with a construction made of wire or some other material to prevent rodents with very strong teeth from being able to destroy the growing platform as a whole.

1-20. (canceled)

21. A growing platform with the facility for receiving growing media as the basis for the growth of green plants,
characterized in that
an additional covering (a/2) comes over the basic container (a/1), which covering has two covers oriented level one above the other, namely cover (a/2b) and cover (a/2a), cover (a/2b) having openings that are only sufficiently large for the green matter to pass through; the cover (a/2a), on the other hand, because of its execution at a distance from the cover (a/2b), prevents the animals from being able to eat the green material down too far; this ensures that the direction of growth of the green matter through the cover (a/2b) remains in the direction of the cover (a/2a).

22. The growing platform according to claim 21, which comprises a third cover (a/3) disposed to ensure a greenhouse effect in conjunction with renewed growth of the green matter, and preventing animals from being able to disturb the growth.

23. The growing platform according to claim 21, wherein said covering assembly (a/2) is partly or wholly formed of a wire mesh.

24. The growing platform according to claim 21, wherein
said covering assembly (a/2) has strips or bars oriented in parallel, having a width of at least 2 cm and running non-parallel adjacent to one another in a horizontal sense, but arranged vertically adjacent to one another, to achieve a height of at least 2 cm;
a cover disposed below said parallel-oriented strips or bars, facing towards the growing media, and covering an entire area, said cover having holes formed therein sufficiently large to permit growing passage of the green matter, but not a stem thickening at a growing bottom of the green matter in a vicinity of the growing media, to prevent the animals from pulling out the green matter complete with roots thereof and from eating the green matter too far down and disturbing a regrowth thereof.

25. The growing platform according to claim 22, wherein said basic container (a/1), said covering assembly (a/2), and said third cover (a/3) are formed with openings enabling air exchange and circulation for the assembly.

26. The growing platform according to claim 21, formed as an integral part of an animal shelter, and wherein the green matter is selected for animal consumption.

27. The growing platform according to claim 22 formed as a unit consisting of said basic container (a/1), said covering assembly (a/2), said third cover (a/3), hinges (a/4) mounting said third cover to said basic container (a/1) or to said covering assembly (a/2), and locking means (a/5a,a/5b,a/5c) for locking the assembly.

28. The growing platform according to claim 22, which comprises furniture straps forming hinges removably mounting at least one of said covering assembly (a/2) or said third cover (a/3) to said basic container (a/1).

29. The growing platform according to claim 22, wherein said basic container (a/1), said covering assembly (a/2), and said third cover (a/3) are configured for connection to another and inside one another as a plug-in system, and as a stable unit, without the animals being able to open the assembly or individual parts thereof.

30. The growing platform according to claim 21, wherein said growing matter in said basic container is selected from the group consisting of soil, granulate, seeds, and water, and which further comprises a moisture outlet means (a/13) connected to said basic container (a/1) for exhausting excess moisture.

31. The growing platform according to claim 21, wherein said basic container (a/1) is configured to receive therein a refill pack (repeat purchase pack) (a/21) filled with growing substances (soil, granulates, etc.) and seeds (plants).

32. The growing platform according to claim 31, which comprises a refill pack (repeat purchase pack) (a/21) dimensioned for placement in said basic container and having a base with at least one of protrusions and recesses enabling corresponding parts of said basic container (a/1) to mate with a substantially perfect fit.

33. The growing platform according to claim 32, wherein said basic container (a/1) has an inner base formed, at or on said inner base, with transverse struts or poles, securely anchored over a length, or a width, or a diagonal, or a vertical thereof, fitting substantially perfectly into the recesses or protrusions of said base of said refill pack (a/21), such that non-standard packs of growing substances and seeds (plants) will not properly fit into the assembly.

34. The growing platform according to claims 32, wherein said refill pack (repeat purchase pack) (a/21) is manufactured from materials which decompose after a given period in contact with water.

35. The growing platform according to claims 32, which comprises a fleece, facing towards said base, disposed in said refill pack (repeat purchase pack) (a/21) or in said basic container (a/1), said fleece acting as a wicking agent with a task of water transport for renewed growth, or also initial growth, to roots (capillary effect, blotting paper principle) of the green matter.

36. The growing platform according to claims 32, wherein said refill pack (repeat purchase pack) (a/21) includes moisture outlet means for protecting against rot and mold attack or saturation of the plant material in said refill pack.

37. The growing platform according to claim 21, wherein said basic container (a/1) further includes holders to enable attachment of rodent stones or mineral stones.

38. The growing platform according to claim 21, wherein said basic container (a/1) further includes holders, disposed around said basic container, for permitting attachment of wood materials (i.e., palisade fence), enabling the animals to satisfy need to gnaw.

39. The growing platform according to claim 22, which comprises a wire jacket disposed to enclose said basic container (a/1) and said third cover (a/3) to prevent the animals from being able to damage said basic container (a/1) and said third cover (a/3).

40. In combination with the growing platform assembly according to claim 21, a refill pack (repeat purchase pack) (a/21) configured for placement in the basic container and having a base with protrusions and/or recesses enabling corresponding parts of the basic container (a/1) to mate with a substantially perfect fit.

41. A growing platform assembly, comprising:
a basic container for receiving and holding therein growing media forming a basis for growing green matter;
a covering assembly disposed on said basic container, said covering assembly including a first cover and a second cover disposed level one above the other, said second cover having openings formed therein having a size sufficiently large for green matter to pass through, and said first cover being disposed at a spacing distance from said second cover to prevent the green matter to be eaten or torn or cut down too far and defining a direction of growth of the green matter through said second cover in a direction of said first cover.
